(19) United States
(12) Patent Application Publication
(10) Pub. No.: US 2019/0153930 A1
(43) Pub. Date: May 23, 2019

(54) ELECTRICALLY ASSISTED TURBOCHARGERS WITH INTEGRATED ONE-WAY CLUTCHES AND ENGINES AND VEHICLES UTILIZING THE SAME

(71) Applicant: GM GLOBAL TECHNOLOGY OPERATIONS LLC, DETROIT, MI (US)

(72) Inventor: Cesare Maria Meano, Torino (IT)

(21) Appl. No.: 15/818,853

(22) Filed: Nov. 21, 2017

(51) Int. Cl. F02B 37/10; F02B 39/10; F02B 67/04

(52) U.S. Cl. CPC F02B 37/10; F02B 33/40; F02B 67/04; F02B 39/10

(57) ABSTRACT

A turbocharger includes a turbine wheel configured to impart torque to a drive shaft, a compressor wheel configured to be driven by a driven shaft, a one-way clutch operatively connecting the drive shaft and the driven shaft such that the drive shaft can impart torque to the driven shaft and the driven shaft can overrun the drive shaft, and a motor-generator capable of imparting torque to the driven shaft or the compressor wheel, and/or generating an electric current. The motor-generator generates electric current via torque provided from the drive shaft. An energy storage device can be selectively regenerated by electric current generated by the motor-generator. The motor-generator is configured to alternately regenerate the energy storage device and drive the driven shaft at overrun speeds relative to the drive shaft. The turbine wheel can be driven by internal combustion engine (ICE) exhaust. An ICE may utilize a plurality of such turbochargers.

### BACKGROUND

Internal combustion engines (ICE) are often called upon to generate considerable levels of power for prolonged periods of time on a dependable basis. Many such ICE assemblies employ a supercharging device, such as an exhaust gas turbine driven turbocharger, to compress the airflow before it enters the intake manifold of the engine in order to increase power and efficiency.

Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

A typical turbocharger includes a central shaft that is supported by one or more bearings and transmits rotational motion between an exhaust-driven turbine wheel and an air compressor wheel. Both the turbine and compressor wheels are fixed to the shaft, which in combination with various bearing components constitute the turbocharger's rotating assembly.

The inertia of such a rotating assembly typically impacts the response of a turbocharger, wherein the diameter of the turbine wheel is one of the main factors. On the other hand, because the turbocharger is generally efficient over a specific range of rotational speeds and airflows, the diameter of the turbine wheel is also a major factor behind generating the necessary airflow for increased engine power. Such considerations frequently demand a compromise between maximum engine power output and response.

### SUMMARY

Provided is a turbocharger, including a turbine wheel configured to impart torque to a drive shaft, a compressor wheel configured to be driven by a driven shaft, a one-way clutch operatively connecting the drive shaft and the driven shaft such that the drive shaft can impart torque to the driven shaft and the driven shaft can overrun the drive shaft, and a motor-generator capable of selectively imparting torque to the driven shaft or the compressor wheel, and/or generating an electric current. The motor-generator can generate electric current via torque provided from the drive shaft. The turbocharger can further include an electrical energy storage device, and the energy storage device can be selectively regenerated by the electric current generated by the motor-generator. The turbocharger can further include an electrical energy storage device, and the motor-generator can be configured to alternately regenerate the energy storage device and drive the driven shaft at overrun speeds relative to the drive shaft. The turbocharger can further include a programmable controller configured to control the motor-generator.

Also provided is an internal combustion engine. The internal combustion engine includes a cylinder block defining a cylinder, a cylinder head mounted to the cylinder block and configured to supply air and fuel to the cylinder for combustion therein, an exhaust manifold operatively connected to the cylinder head and an outlet configured to expel exhaust from the cylinder, and a turbocharger configured to pressurize an airflow received from the ambient for delivery to the cylinder. The turbocharger includes a turbine wheel configured to be driven by the exhaust from the outlet and impart torque to a drive shaft, a compressor wheel configured to pressurize an airflow received from the ambient for delivery to the cylinder when driven by a driven shaft, a one-way clutch operatively connecting the drive shaft and the driven shaft such that the drive shaft can impart torque to the driven shaft and the driven shaft can overrun the drive shaft, and a motor-generator capable of selectively imparting torque to the driven shaft or the compressor wheel, and/or generating an electric current. The motor-generator can generate electric current via torque provided from the drive shaft. The internal combustion engine can further include an electrical energy storage device, and the energy storage device can be selectively regenerated by the electric current generated by the motor-generator. The internal combustion engine can power a vehicle, and the motor-generator can regenerate the energy storage device during non-braking vehicle operation when the torque transmitted to the driven shaft by the turbine wheel exceeds the desired torque, and during vehicle braking events. The internal combustion engine can further include an electrical energy storage device, and the motor-generator can be configured to alternately regenerate the energy storage device and drive the driven shaft at overrun speeds relative to the drive shaft. The internal combustion engine can further include a programmable controller configured to control the motor-generator.

Also provided is a vehicle, including a driven wheel and a powertrain including an internal combustion engine and a transmission assembly operatively connected to the engine and configured to transmit engine torque to the driven wheel. The engine can include a cylinder block defining a cylinder, a cylinder head mounted to the cylinder block and configured to supply air and fuel to the cylinder for combustion therein, an exhaust manifold operatively connected to the cylinder head and having a first outlet and a second outlet, and each of the first and second outlets can be configured to expel exhaust from the cylinder, a first turbocharger, and a second turbocharger. The first turbocharger can include a first turbine wheel configured to be driven by the exhaust from the first outlet and impart torque to a first drive shaft, a first compressor wheel configured to pressurize an airflow received from the ambient for delivery to the cylinder when driven by a first driven shaft, a first one-way clutch operatively connecting the first drive shaft and the first driven shaft such that the first drive shaft can impart torque to the first driven shaft and the first driven shaft can overrun the first drive shaft, and a first motor-generator capable of selectively imparting torque to the first driven shaft or the first compressor wheel, and/or generating an electric current via the first drive shaft. The second turbocharger can include a second turbine wheel configured to be driven by the exhaust from the second outlet and impart torque to a second drive shaft, a second compressor wheel configured to pressurize an airflow received from the ambient for delivery to the cylinder when driven by a second driven shaft, a second one-way clutch operatively connecting the second drive shaft and the second driven shaft such that the second drive shaft can impart torque to the second driven shaft and the second driven shaft can overrun the second drive shaft, a second motor-generator capable of selectively imparting torque to the second driven shaft or the second compressor wheel, and/or generating an electric current via the second drive shaft.

The first turbocharger can be a low-flow turbocharger. The second turbocharger can be a high-flow turbocharger. The vehicle can further include a flow control device configured to selectively direct the exhaust to the first turbocharger and the second turbocharger. The vehicle can further include a programmable controller configured to regulate and coordinate operation of the flow control device, the first motor-generator, and the second motor-generator. The vehicle can further include an electrical energy storage device, and the energy storage device can be selectively regenerated by the electric current generated by one or more of the first motor-generator and the second motor-generator. The first motor-generator can regenerate the energy storage device during non-braking vehicle operation when the torque transmitted to the first driven shaft by the first turbine wheel exceeds a desired torque, and during vehicle braking events. The second motor-generator can regenerate the energy storage device during non-braking vehicle operation when the torque transmitted to the second driven shaft by the second turbine wheel exceeds a desired torque, and during vehicle braking events. The vehicle can further include a programmable controller configured to direct the electric current generated by one or more of the first motor-generator and the second motor-generator to the energy storage device. The vehicle can further include an electrical energy storage device, and the first motor-generator can be configured to alternately regenerate the energy storage device and drive the first driven shaft at overrun speeds relative to the first drive shaft, and the second motor-generator can be configured to alternately regenerate the energy storage device and drive the second driven shaft at overrun speeds relative to the second drive shaft.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic depiction of a vehicle, according to one or more embodiments;

FIG. 2 illustrates a schematic partially cross-sectional top view of an engine, according to one or more embodiments;

FIG. 3 illustrates a schematic partially cross-sectional top view of an engine, according to one or more embodiments;

FIG. 4 illustrates a schematic cross-sectional view of a representative turbocharger, according to one or more embodiments;

FIG. 5A illustrates a schematic view of a turbocharger, according to one or more embodiments; and

FIG. 5B illustrates a schematic view of a turbocharger, according to one or more embodiments.

### DETAILED DESCRIPTION

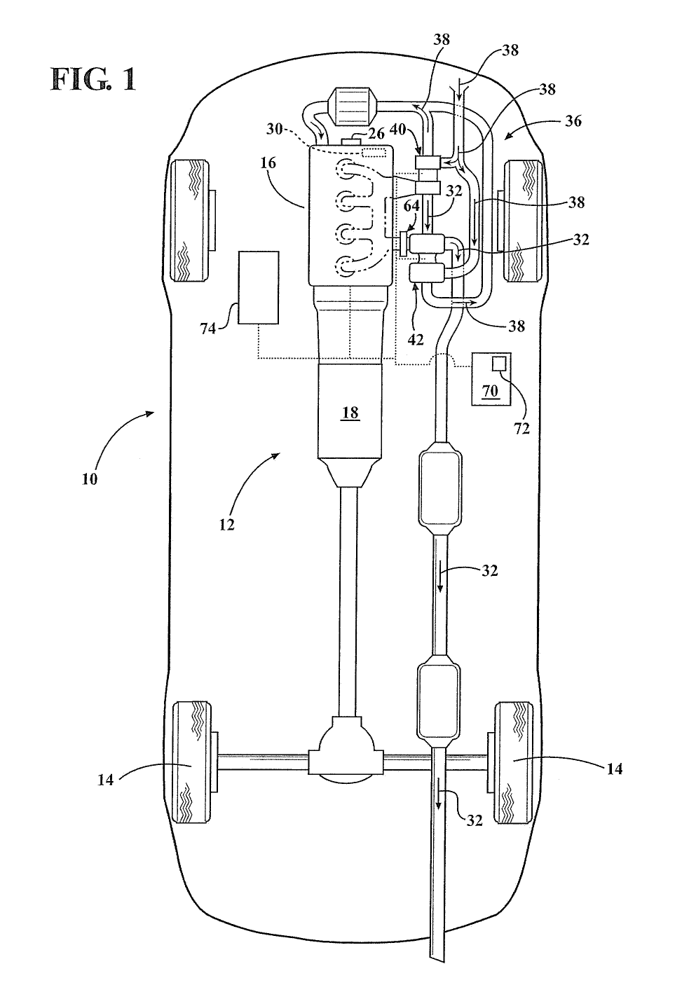

Referring to the drawings, wherein like reference numbers correspond to like or similar components throughout the several figures, FIG. 1 illustrates a vehicle 10 employing a powertrain 12 for propulsion thereof, for example via driven wheels 14. As shown, the powertrain 12 includes an internal combustion engine 16, such as a spark- or compression-ignition type, and a transmission assembly 18 operatively connected thereto. The powertrain 12 may be a hybrid system combining the engine 16 with one or more electric motor/generators, which are not shown, but the existence of which may be envisioned by those skilled in the art.

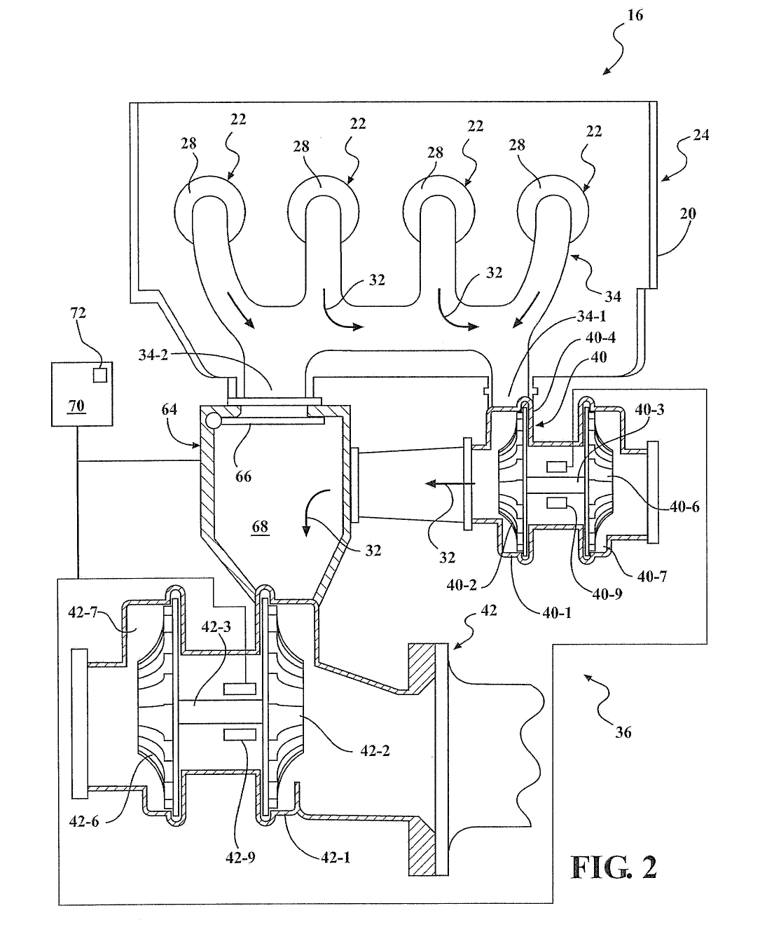

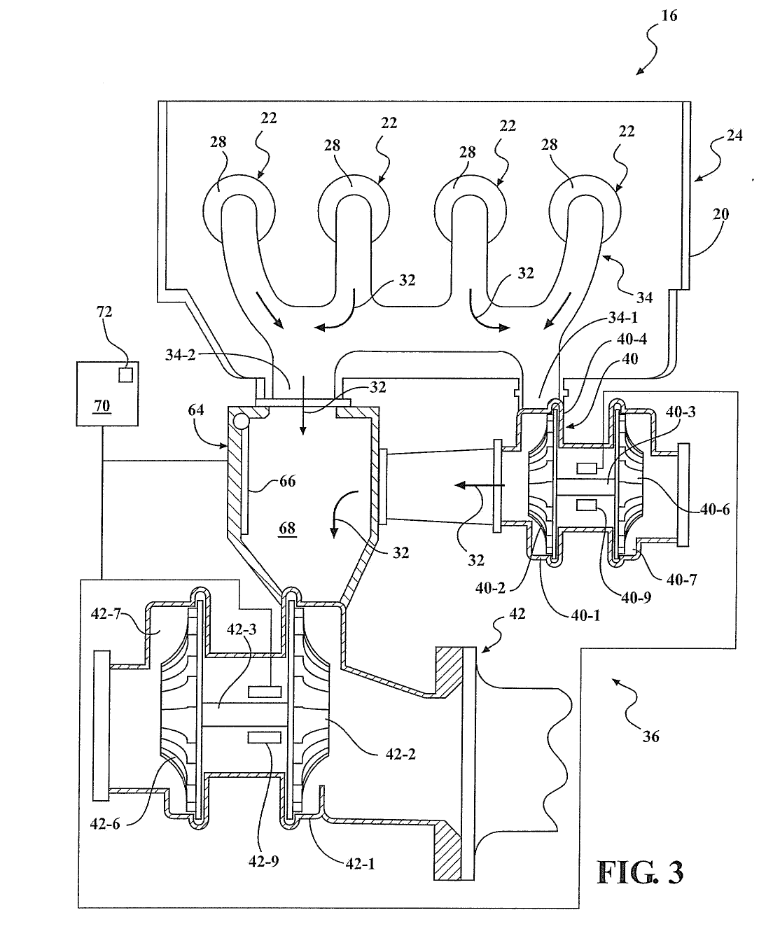

FIG. 2 illustrates engine 16, which includes a cylinder block 20 having a plurality of cylinders 22 arranged therein, and a cylinder head 24 that is mounted on the cylinder block. As shown in FIGS. 2-3, the cylinder head 24 may be integrated into or cast together with the cylinder block 20. The cylinder head 24 receives air and fuel to be used inside the cylinders 22 for subsequent combustion. Each cylinder 22 includes a piston configured to reciprocate therein. Combustion chambers 28 are formed within the cylinders 22 between the bottom surface of the cylinder head 24 and the tops of the pistons. Each of the combustion chambers 28 receives fuel and air from the cylinder head 24 that form a fuel-air mixture for subsequent combustion inside the subject combustion chamber. Although an in-line four-cylinder engine is shown, nothing precludes the present disclosure from being applied to an engine having a different number and/or arrangement of cylinders.

Further optional components can include a first fluid pump 26 and a second fluid pump 30 which are arranged on the engine 16. The first fluid pump 26 is configured to circulate pressurized coolant 27 to remove heat from various subsystems and components, such as pistons and valves, of the engine 16, as understood by those skilled in the art. The second fluid pump 30 is configured to circulate pressurized oil 31 for lubricating sensitive components, such as bearings, of the engine 16. Each of the first and second fluid pumps 26, 30 may be driven mechanically, directly by rotating engine components of the engine 16, such as the crankshaft, or by a respective electric motor (not shown).

The engine 16 also includes a crankshaft (not shown) configured to rotate within the cylinder block 20. The crankshaft is rotated by the pistons as a result of an appropriately proportioned fuel-air mixture being burned in the combustion chambers 28. After the air-fuel mixture is combusted inside a specific combustion chamber 28, the reciprocating motion of a particular piston serves to expel post-combustion products (“exhaust”) 32 from the respective cylinder 22. The cylinder head 24 is also configured to expel exhaust 32 from the combustion chambers 28 via an exhaust manifold 34. As shown in FIGS. 2-3, the exhaust manifold 34 may be internally cast, i.e., integrated, into the cylinder head 24. Exhaust runners from different cylinders 22 are joined together in the exhaust manifold 34, thus allowing two separate outlets, a first outlet 34-1 and a second outlet 34-2, to be formed for scavenging the expelled exhaust 32 from all cylinders 22.

The engine 16 also includes a turbocharging system 36 configured to develop boost pressure, i.e., pressurize an airflow 38 that is received from the ambient, for delivery to the cylinders 22. The turbocharging system can include one or more turbochargers. For the purpose of illustration, the turbocharging system 36 is illustrated as a two-stage forced induction arrangement for the engine 16 including a low-flow (i.e., high-pressure) turbocharger 40 that is in fluid communication with the exhaust manifold 34 and configured to be driven by the exhaust 32 from the first outlet 34-1. The low-flow turbocharger 40 pressurizes and discharges the airflow 38 to the cylinders 22 at lower flow rates of the exhaust 32, which are typically generated at lower rotational speeds, such as below approximately 3,000 RPM, of the engine 16.

The two-stage turbocharging system 36 also includes a high-flow (i.e., low-pressure) turbocharger 42 that is in fluid communication with the exhaust manifold 34 and configured to be driven by the exhaust 32 from the second outlet 34-2. The high-flow turbocharger 42 pressurizes and discharges the airflow 38 to the cylinders 22 at higher flow rates of the exhaust 32, which are typically generated at intermediate and higher rotational speeds, such as around 3,000 RPM and above, of the engine 16. To support such distinct engine speed ranges and rates of airflow 38, the low-flow turbocharger 40 is typically sized comparatively smaller, and thus has a smaller rotating inertia than the high-flow turbocharger 42. The turbocharging system 36 may also employ a bypass (not shown) with a check valve or an actively controlled valve to permit the pressurized airflow 38 to be routed from the high-flow turbocharger 42 to the cylinders 22 when flow rates exceed limits of the low-flow turbocharger 40. As such, the exhaust manifold 34 is operatively connected to the cylinder head 24, while the two separate outlets 34-1 and 34-2 permit two turbochargers 40, 42 to be mounted sufficiently apart.

The two-stage turbocharging system 36 may be configured to operate as a sequential system, wherein at least in some engine speed ranges (e.g., lower engine speeds) both low-flow and high-flow turbochargers operate simultaneously, i.e., with operational overlap. The two-stage turbocharging system 36 may also be configured to generate boost pressure as a staged system, for example wherein the low-flow and high-flow turbochargers generate boost pressure in sequence, without any operational overlap. For example, the first, larger flow turbocharger can boost intake air pressure to the greatest extent possible (e.g., two times the intake pressure) and the subsequent smaller flow turbocharger(s) can further compress the intake air from a previous stage (e.g., to an additional two times intake pressure, for a total boost of four times atmospheric pressure).

The engine 16 additionally includes an induction system that may include an air duct and an air filter upstream of the turbochargers 40, 42 configured to channel the airflow 38 from the ambient to the turbocharging system 36. Although the induction system is not shown, the existence of such would be appreciated by those skilled in the art. Each of the turbochargers 40, 42 may also be fluidly connected to an intake manifold (not shown) that is configured to distribute the pressurized airflow 38 to each of the cylinders 22 for mixing with an appropriate amount of fuel and subsequent combustion of the resultant fuel-air mixture.

As shown in FIGS. 2-3, the turbocharging system 36 also includes a flow control device 64. The flow control device 64 is mounted to the cylinder head 24, and is attached directly to and is in fluid communication with the second outlet 34-2 of the exhaust manifold 34. The high-flow turbocharger 42 is mounted to the flow control device 64 such that the exhaust 32 may only access the high-flow turbocharger by first passing through the flow control device. A fluid flow path out of the first manifold outlet 34-1 is maintained unobstructed so as to supply the exhaust 32 to the low-flow turbocharger 40, while another fluid flow path from the second manifold outlet 34-2 is connected to the flow control device 64.

The flow control device 64 includes a valve 66 and a chamber 68, and is used to selectively open and close the fluid flow path from the second manifold outlet 34-2 into the high-flow turbocharger 42. The flow control device 64 is also open, i.e., fluidly connected with the low-flow turbine housing 40-1. As shown, the valve 66 may be configured as a door designed to pivot around an axis Y in order to selectively open and close the flow control device 64. When the flow control device 64 is closed and the valve 66 blocks the second manifold outlet 34-2, the exhaust 32 naturally flow into the low-flow turbocharger 40. Following the low-flow turbocharger 40, the exhaust 32 is exited from the low-flow turbine housing 40-1 into the high-flow turbine housing 42-1, downstream of the valve 66. On the other hand, because the chamber 68 is fluidly connected to the low-flow turbine housing 40-1, when the valve 66 fully opens the second manifold outlet 34-2, pressure across the two sides of the low-flow turbine housing 40-1 equalizes, the exhaust 32 will naturally flow into the high-flow turbine housing 42-1.

The valve 66 can be sized in order to select the operational transition point between low-flow turbine wheel 40-2 and high-flow turbine wheel 42-2. Also, opening into the flow control device 64 may be modulated via the valve 66 to adjust or vary the flow of exhaust 32 through the low-flow turbine housing 40-1, thus varying the amount of overlap between operation of the low-flow and high-flow turbochargers 40, 42. Also the relative sizes of the low-flow and high-flow turbine housings 40-1, 42-1 are selected to vary the operation transition point between low-flow turbine wheel 40-2 and high-flow turbine wheel 42-2. Accordingly, the opening into the chamber 68 of the valve 66 can also be controlled to effect sequential operation of the two turbochargers 40, 42. Through such an arrangement, the flow control device 64 is configured to selectively direct the exhaust 32 to the low-flow turbocharger 40 and the high-flow turbocharger 42, thus effectively transitioning between the low-flow turbocharger and the high-flow turbocharger during operation of the engine 16.

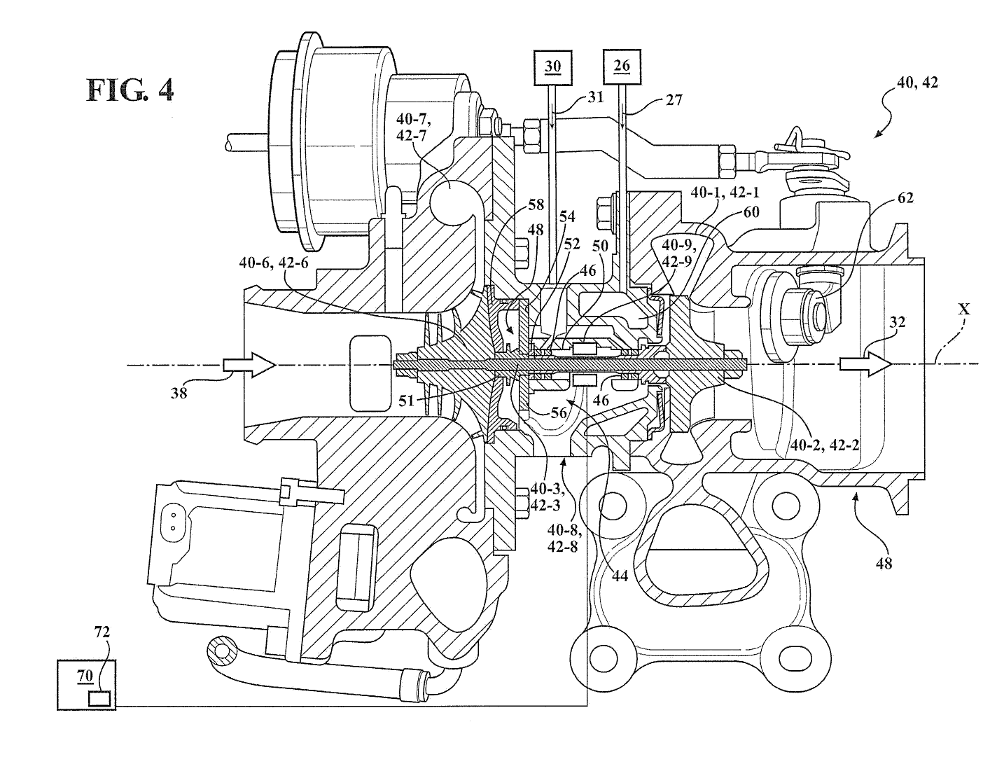

As shown in FIG. 4, each of the turbochargers 40 and 42 includes a rotating assembly, comprising respective turbine wheels 40-2 and 42-2 mounted on shafts 40-3 and 42-3, respectively. The turbine wheels 40-2 and 42-2 are configured to be rotated along with the respective shafts 40-3, 42-3 by exhaust 32 emitted from the cylinders 22. The turbine wheels 40-2 and 42-2 are typically constructed from a temperature and oxidation resistant material, such as a nickel-chromium-based alloy, to reliably withstand temperatures of the exhaust 32.

The turbine wheels 40-2 and 42-2 are disposed inside respective turbine housings 40-1 and 42-1 that are typically constructed from metal (e.g., cast iron or steel) and include an appropriately configured, i.e., designed and sized, respective turbine volutes or scrolls. The turbine scrolls of the turbine housings 40-1 and 42-1 receive the exhaust 32 and direct the gasses to the respective turbine wheels 40-2 and 42-2. The turbine scrolls are configured to achieve specific performance characteristics, such as efficiency and response, of the respective turbocharger 40 and 42. Each of the turbine housings 40-1 and 42-1 may also include an integrated waste-gate valve (not shown) and/or be variable geometry turbochargers to facilitate more precise control over boost pressures generated by the turbocharging system 36 (e.g., the transition and/or overlap between operation of the low-flow turbocharger 40 and the high-flow turbocharger 42). The flow control device 64 may serve as a waste-gate for the low-flow turbocharger 40.

Each turbocharger 40, 42 further includes a compressor wheel 40-6 and 42-6 mounted on the respective shafts 40-3, 42-3. Accordingly, for each turbocharger 40, 42, the respective turbine wheels 40-2 and 42-2 and compressor wheels 40-6 and 42-6 are mechanically coupled via the common respective shafts 40-3, 42-3. The compressor wheels 40-6 and 42-6 are configured to pressurize the airflow 38 being received from the ambient or the other compressor wheel 40-6 or 42-6 for eventual delivery to the cylinders 22. The compressor wheels 40-6 and 42-6 are disposed inside a respective compressor cover 40-7 and 42-7. Each compressor cover 40-7, 42-7 is typically constructed from metal (e.g., aluminum) and includes a respective compressor volute or scroll. As understood by those skilled in the art, the variable flow and force of the exhaust 32 influences the amount of boost pressure that may be generated by each compressor wheel 40-6 and 42-6 of the respective turbochargers 40 and 42 throughout the operating range of the engine 16. Each compressor wheel 40-6, 42-6 is typically formed from a light-weight and/or high-strength metal (e.g., an aluminum alloy) that provides the compressor wheel with reduced rotating inertia and quicker spin-up response.

Each of the turbochargers 40, 42 can optionally include a bearing system 44 configured to support one or more of the respective turbine wheel 40-2, 42-2, the shaft 40-3, 42-3, and the compressor wheel 40-6, 42-6. As shown, the bearing systems 44 of the turbochargers 40 and 42 are mounted in respective bores 50 along the axis X within respective bearing housings 40-8 and 42-8. The bearing housings 40-8 and 42-8 may be formed from a suitable robust material (e.g., an aluminum-silicon alloy or nodular cast iron) capable of withstanding appropriate thermal and mechanical stresses, and are configured to maintain dimensional stability of the bore 50. The bearing system 44 in each turbocharger 40, 42 may include journal bearings 46 and a thrust bearing assembly 48, both of which are described in detail below.

Specifically, each shaft 40-3, 42-3 is generally supported for rotation about the axis X via a set of journal bearings 46. The journal bearings 46 are mounted in the bore 50 along the axis X within a respective bearing housing 40-8 and 42-8 and is cooled by the pressurized coolant 27 supplied via the first fluid pump 26 and lubricated by the pressurized oil 31 supplied via the second fluid pump 30. The journal bearings 46 are configured to control radial motion and vibrations of the respective shafts 40-3, 42-3.

Additionally, the bearing system 44 of each turbocharger 40, 42 can include a thrust bearing assembly 48. Each thrust bearing assembly 48 is configured to absorb thrust forces generated by the one or more of the respective turbine wheel 40-2, 42-2, the shaft 40-3, 42-3, and the compressor wheel 40-6, 42-6 while the turbocharger 40, 42 is pressurizing the airflow 38. As shown in FIG. 4, the thrust bearing assembly 48 includes a thrust collar 51 and a thrust washer 52. Each bearing housing 40-8, 42-8 includes a thrust wall 54. The thrust bearing assembly 48 also includes a thrust plate 56 that is held in place by a thrust retainer 58 against the thrust wall 54.

The low-flow turbocharger 40 further includes a first motor-generator 40-9 and/or the high-flow turbocharger 42 further includes a second motor-generator 42-9. The motor-generators 40-9, 42-9 are configured to selectively assist the exhaust 32 in driving the respective turbocharger 40 and/or 42, for example via power supplied by electrical energy storage device 74. Optionally, as necessitated by the desired performance of the engine 16, the first motor-generator 40-9 may be operatively connected to and incorporated into the high-flow turbocharger 42, and/or the second motor-generator 42-9 may be operatively connected to and incorporated into the low-flow turbocharger 40. In particular, motor-generators 40-9, 42-9 are configured to selectively assist the exhaust 32 in driving the respective turbocharger 40 and/or 42 during spool up to compensate for the insufficient boost produced by a compressor wheel 40-6 and/or 42-6 known as “turbo lag”. The motor-generators 40-9 and/or 42-9 are additionally or alternatively configured to generate an electric current when driven via the low-flow turbocharger 40 and/or the high-flow turbocharger 42. In one example, when the torque generated by the turbine wheel 40-2 and/or 42-2 via exhaust 32 is in excess of what is necessary to power the compressor wheel 40-6 and/or 42-6, the motor-generators 40-9 and/or 42-9 can limit the power translated to the compressor wheel 40-6 and/or 42-6 and generate electric current. The generated electric current can regenerate (e.g., charge) the energy storage device 74, or provide electric current to one or more other power-consumers. In another example, the motor-generators 40-9 and/or 42-9 can generate electric current via regenerative braking by converting some or all of the turbine wheel 40-6 and/or 42-6 torque to electric current during a braking event. One or both turbine wheels 40-2, 42-2 in driving the motor generators 40-9 and/or 42-9 also increase backpressure on the engine, which assists in the braking effort.

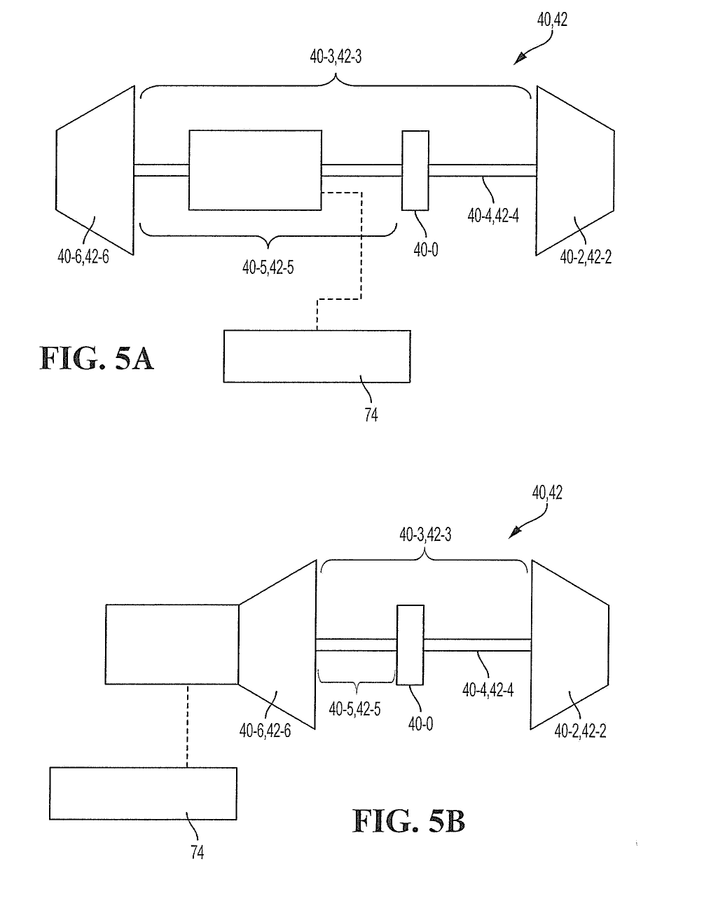

As shown in FIGS. 2-4, the motor-generators 40-9 and/or 42-9 can be incorporated into the bearing housing 40-8 and/or 42-8 of the respective turbocharger 40 and/or 42. The motor-generators 40-9 and 42-9 can be attached to the respective shafts 40-3, 42-3 by various means, as is known in the art. Alternatively, the motor-generators 40-9 and 42-9 can be operatively connected to, or integrated with, the compressor wheels 40-6 and 42-6, rather than imparting torque to the respective shafts 40-3, 42-3. Specifically, the motor-generators 40-9 and 42-9 can be operatively connected to, or integrated with, the compressor wheels 40-6 and 42-6 on the side of the compressor wheels 40-6 and 42-6 opposite the turbine wheels 40-6 and 42-6; such a configuration is shown in FIG. 5B below. One of skill in the art will know that embodiments described in reference to the motor-generator 40-9,42-9 orientations shown in FIGS. 2-4 do not preclude an analogous disclosure of the same embodiments utilizing the motor-generators 40-9 and 42-9 orientations shown in FIG. 5B.

As noted above, the journal bearings 46 and the thrust bearing assembly 48 of each turbocharger 40, 42 are cooled by the pressurized coolant 27 circulated through the respective coolant jackets 60. To take advantage of the cooling provided within the bearing housings 40-8, 42-8, the first motor-generator 40-9 and the second motor-generator 42-9 can be arranged within the respective bearing housings specifically proximate to the coolant jacket 60 for effective cooling thereby. Such convective cooling of the motor-generators 40-9, 42-9 is intended to facilitate reliable performance of the motor-generators. The turbochargers 40, 42 may additionally or alternatively comprise a dedicated cooling circuit (not shown) for effecting heat transfer with one or both motor-generators 40-9 and 42-9.

Turbine wheels 40-2 and 42-2 and compressor wheels 40-6 and 42-6 are mechanically coupled via the common respective shafts 40-3, 42-3 such that rotational characteristics (e.g., rotational speed) are shared by each turbine wheel 40-2 or 42-2 and its respective compressor wheel 40-6 or 42-6. Accordingly, when a motor-generator is utilized to assist a turbocharger in order to drive the appurtenant compressor wheel, energy is wasted in also driving the appurtenant turbine wheel. Accordingly, as shown in FIGS. 5A-B, a turbocharger 40, 42 is provided which incorporates a freewheel, or a one-way clutch 40-0, 42-0. One-way clutch 40-0, 42-0 bifurcates shaft 40-3, 42-3 between compressor wheel 40-6, 42-6 and turbine wheel 40-2 or 42-2, as shown in FIG. 5B, or between the motor-generator 40-9, 42-9 and turbine wheel 40-2 or 42-2, as shown in FIG. 5A, to form a drive shaft 40-4, 42-4 and a driven shaft 40-5, 42-5. The drive shaft 40-4, 42-4 mechanically couples the turbine wheel 40-2 or 42-2 to the one-way clutch 40-0, 42-0, and the driven shaft 40-5, 42-5 mechanically couples the one-way clutch 40-0, 42-0 to the compressor wheel 40-6, 42-6. The motor-generators 40-9, 42-9 can each drive the one or more driven shafts 40-4, 42-4 or the one or more compressor wheels 40-6, 42-6, in various embodiments. As illustrated in FIG. 5A, the driven shaft 40-5, 42-5 mechanically couples the motor-generator 40-9, 42-9 to the one-way clutch 40-0, 42-0 and the compressor wheel 40-6, 42-6. In such an embodiment, each driven shaft 40-5, 42-5 can comprise two shafts, for example one shaft on either side of the motor-generator 40-9, 42-9. As illustrated in FIG. 5B, the driven shaft 40-5, 42-5 mechanically couples the one-way clutch 40-0, 42-0 to the compressor wheel 40-6, 42-6 on one side of the compressor wheel 40-6, 42-6, and the motor-generator 40-9, 42-9 mechanically couples to the compressor wheel 40-6, 42-6 on an opposite side of the compressor wheel 40-6, 42-6.

The one-way clutch 40-0, 42-0 is disposed such that the driven shaft 40-5, 42-5 can overrun (i.e., rotate at a greater speed than) the drive shaft 40-4, 42-4. Accordingly, when the motor-generator 40-9, 42-9 is used to drive the compressor wheel 40-6, 42-6 directly or via the driven shaft 40-5, 42-5, energy is not wasted by similarly driving the turbine wheel 40-2 or 42-2, the latter having significantly higher inertia that the respective compressor wheel 40-6, 42-6 due to the heavy material of construction (e.g., high temperature-resistant materials). This is particularly beneficial during turbocharger 40, 42 spool up, as higher boost pressure is generated more quickly, thereby reducing turbo lag, for example. Further, by not energizing the turbine wheel 40-2 or 42-2, less electrical energy is required to effect a desired movement of the compressor wheel 40-6 or 42-6. Additionally, because the increased boost pressure allows more fuel to be injected into the one or more cylinders 22 of engine 16, the flow rate and/or enthalpy of the exhaust 32 further increases the output torque of the turbine wheel 40-2 or 42-2. Accordingly, a desired boost pressure can be effected much more quickly, and with less energy expenditure. While additional inertia is added by the one way clutch 40-0, 42-0 to the rotating assembly of each turbocharger 40, 42, the added inertia can be compensated by the motor-generators 40-9, 42-9. Further, the added inertia of the one-way clutch 40-0, 42-0 is less than the inertia of the corresponding turbine wheel 40-2 or 42-2 which it decouples, and therefore less energy is required during spool up and other boosting events.

Further, the one-way clutch 40-0, 42-0 advantageously does not interfere with electric current generation by the motor-generator 40-9, 42-9. When boost pressure is desired, a corresponding amount of desired torque must be imparted to the compressor wheels 40-6, 42-6 in order to generate the desired boost pressure. In some instances, exhaust 32 flow may be insufficient to drive the turbine wheel 40-2, 42-2 to generate and transmit the desired amount of torque to the compressor wheels 40-6, 42-6; accordingly, one or both motor-generators 40-9 and/or 42-9 can drive the one or more compressor wheels 40-6, 42-6 or driven shafts 40-5 and 42-5 to provide the desired boost pressure (e.g., to compensate for turbo lag). Such operation of one or both motor-generators 40-9 and/or 42-9 can be controlled by a controller 70, for example. When exhaust 32 flow becomes sufficient to drive the turbine wheel 40-2, 42-2 to generate and transmit the desired amount of torque to the compressor wheels 40-6, 42-6, the one-way clutch 40-0, 42-0 automatically effects torque transfer from the drive shaft 40-4, 42-4 to the driven shaft 40-5 and 42-5. As the torque transferred from the drive shaft 40-4, 42-4 to the driven shaft 40-5 and 42-5 increases, torque imparted by one or both motor-generators 40-9 and/or 42-9 to drive the one or more compressor wheels 40-6, 42-6 or driven shafts 40-5 and 42-5 can be correspondingly reduced or fully eliminated. In some instances, when the turbine wheel 40-2, 42-2 generate torque in excess of what is desired to be transmitted to the compressor wheels 40-6, 42-6, the excess torque can be utilized by one or both motor-generators 40-9 and/or 42-9 to generate electric current. The electric current generated by one or both motor-generators 40-9 and/or 42-9 can be utilized to regenerate electrical power storage device 74. Specifically, during the operation of vehicle 10, one or both motor-generators 40-9 and/or 42-9 can regenerate the energy storage 74 device during non-braking vehicle operation when the torque transmitted to the respective driven shafts 40-5, 42-5, and consequently the respective compressor wheels 40-6, 42-6, by the respective turbine wheels 40-2, 42-2 exceeds a desired torque, and during vehicle braking events. Specifically, the energy storage device 74 can comprise a battery, and regenerating the battery can comprise charging the battery.

The vehicle 10 may additionally include a programmable controller 70 configured to regulate operation of the engine, such as by controlling an amount of fuel being injected into the cylinders 22 for mixing and subsequent combustion with the pressurized airflow 38. The controller 70 may be configured as a central processing unit (CPU) configured to regulate operation of the internal combustion engine 16 (shown in FIG. 1), a hybrid-electric powertrain (not shown), or other alternative types of power plants, as well as other vehicle systems, or a dedicated controller. In order to appropriately control operation of the engine 16, the controller 70 includes a memory, at least some of which is tangible and non-transitory. The memory may be any recordable medium that participates in providing computer-readable data or process instructions. Such a medium may take many forms, including but not limited to non-volatile media and volatile media.

Non-volatile media for the controller 70 may include, for example, optical or magnetic disks, and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 70 may also include a floppy disk, a flexible disk, hard disk, magnetic tape, any other magnetic medium, a CD-ROM, DVD, any other optical medium, etc. The controller 70 can be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the controller 70 or accessible thereby may be stored in the memory and automatically executed to provide the required functionality.

The controller 70 can be programmed to close the flow control device 64 (as shown in FIG. 2) to direct the exhaust 32 to the low-flow turbocharger 40 and open the control valve (as shown in FIG. 3) to direct the exhaust to the high-flow turbocharger 42 depending on operating parameters, such as the load, temperature, and rotational speed, of the engine 16. Accordingly, the controller 70 may be programmed to close the flow control device 64 below a predetermined flow rate 72 of the exhaust 32 and open the control valve at or above the predetermined flow rate.

The controller 70 can be configured to control one or both motor-generators 40-9 and/or 42-9. For example, the controller 70 can be configured to direct the electric current generated by one or more of the first motor-generator 40-9 and the second motor-generator 42-9 to the energy storage device 74. Further, the controller 70 can be configured to regulate and coordinate operation of the flow control device 64, the first motor-generator 40-9, and the second motor-generator 42-9. In one embodiment, for example during turbocharger 40,42 spool up, the controller 70 can determine a required torque to impart to the driven shaft 40-5 and 42-5 or compressor wheels 40-6, 42-6, based on a commanded boost pressure. The controller can impart varying levels of torque to the driven shaft 40-5, 42-5 or compressor wheels 40-6, 42-6 via the one or more motor-generators 40-9, 42-9 such that the combined torque imparted to the driven shaft 40-5, 42-5 or compressor wheels 40-6, 42-6 by the one or more motor-generators 40-9, 42-9 and the corresponding turbine wheels 40-2, 42-2 effects the desired boost pressure.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A turbocharger, comprising:
a turbine wheel configured to impart torque to a drive shaft;
a compressor wheel configured to be driven by a driven shaft;
a one-way clutch operatively connecting the drive shaft and the driven shaft such that the drive shaft can impart torque to the driven shaft and the driven shaft can overrun the drive shaft; and
a motor-generator capable of selectively imparting torque to the driven shaft or the compressor wheel, and/or generating an electric current.

2. The turbocharger of claim 1, wherein the motor-generator generates electric current via torque provided from the drive shaft.

3. The turbocharger of claim 1, further comprising an electrical energy storage device, wherein the energy storage device is selectively regenerated by the electric current generated by the motor-generator.

4. The turbocharger of claim 1, further comprising an electrical energy storage device, wherein the motor-generator is configured to alternately regenerate the energy storage device and drive the driven shaft at overrun speeds relative to the drive shaft.

5. The turbocharger of claim 1, further comprising a programmable controller configured to control the motor-generator.

6. An internal combustion engine, comprising:
a cylinder block defining a cylinder;
a cylinder head mounted to the cylinder block and configured to supply air and fuel to the cylinder for combustion therein;
an exhaust manifold operatively connected to the cylinder head and an outlet configured to expel exhaust from the cylinder; and
a turbocharger configured to pressurize an airflow received from the ambient for delivery to the cylinder, the turbocharger including:
a turbine wheel configured to be driven by the exhaust from the outlet and impart torque to a drive shaft;
a compressor wheel configured to pressurize an airflow received from the ambient for delivery to the cylinder when driven by a driven shaft;
a one-way clutch operatively connecting the drive shaft and the driven shaft such that the drive shaft can impart torque to the driven shaft and the driven shaft can overrun the drive shaft; and
a motor-generator capable of selectively imparting torque to the driven shaft or the compressor wheel, and/or generating an electric current.

7. The internal combustion engine of claim 6, wherein the motor-generator generates electric current via torque provided from the drive shaft.

8. The internal combustion engine of claim 6, further comprising an electrical energy storage device, wherein the energy storage device is selectively regenerated by the electric current generated by the motor-generator.

9. The internal combustion engine of claim 8, wherein the internal combustion engine powers a vehicle, and the motor-generator regenerates the energy storage device during non-braking vehicle operation when the torque transmitted to the driven shaft by the turbine wheel exceeds a desired torque, and during vehicle braking events.

10. The internal combustion engine of claim 6, further comprising an electrical energy storage device, wherein the motor-generator is configured to alternately regenerate the energy storage device and drive the driven shaft at overrun speeds relative to the drive shaft.

11. The internal combustion engine of claim 6, further comprising a programmable controller configured to control the motor-generator.

12. A vehicle comprising:
a driven wheel; and
a powertrain including an internal combustion engine and a transmission assembly operatively connected to the engine and configured to transmit engine torque to the driven wheel, the engine including:
a cylinder block defining a cylinder;
a cylinder head mounted to the cylinder block and configured to supply air and fuel to the cylinder for combustion therein;
an exhaust manifold operatively connected to the cylinder head and having a first outlet and a second outlet, wherein each of the first and second outlets is configured to expel exhaust from the cylinder;
a first turbocharger including:
a first turbine wheel configured to be driven by the exhaust from the first outlet and impart torque to a first drive shaft;
a first compressor wheel configured to pressurize an airflow received from the ambient for delivery to the cylinder when driven by a first driven shaft;
a first one-way clutch operatively connecting the first drive shaft and the first driven shaft such that the first drive shaft can impart torque to the first driven shaft and the first driven shaft can overrun the first drive shaft; and
a first motor-generator capable of selectively imparting torque to the first driven shaft or the first compressor wheel, and/or generating an electric current via the first drive shaft; and
a second turbocharger including:
a second turbine wheel configured to be driven by the exhaust from the second outlet and impart torque to a second drive shaft;
a second compressor wheel configured to pressurize an airflow received from the ambient for delivery to the cylinder when driven by a second driven shaft;
a second one-way clutch operatively connecting the second drive shaft and the second driven shaft such that the second drive shaft can impart torque to the second driven shaft and the second driven shaft can overrun the second drive shaft; and
a second motor-generator capable of selectively imparting torque to the second driven shaft or the second compressor wheel, and/or
generating an electric current via the second drive shaft.

13. The vehicle of claim 12, wherein the first turbocharger is a low-flow turbocharger.

14. The vehicle of claim 12, wherein the second turbocharger is a high-flow turbocharger.

15. The vehicle of claim 12, wherein the engine further comprises a flow control device configured to selectively direct the exhaust to the first turbocharger and the second turbocharger.

16. The vehicle of claim 15, further comprising a programmable controller configured to regulate and coordinate operation of the flow control device, the first motor-generator, and the second motor-generator.

17. The vehicle of claim 12, further comprising an electrical energy storage device, wherein the energy storage device is selectively regenerated by the electric current generated by one or more of the first motor-generator and the second motor-generator.

18. The vehicle of claim 17, wherein the first motor-generator regenerates the energy storage device during non-braking vehicle operation when the torque transmitted to the first driven shaft by the first turbine wheel exceeds a desired torque, and during vehicle braking events, and wherein the second motor-generator regenerates the energy storage device during non-braking vehicle operation when the torque transmitted to the second driven shaft by the second turbine wheel exceeds a desired torque, and during vehicle braking events.

19. The vehicle of claim 17, further comprising a programmable controller configured to direct the electric current generated by one or more of the first motor-generator and the second motor-generator to the energy storage device.

20. The vehicle of claim 12, further comprising an electrical energy storage device, wherein the first motor-generator is configured to alternately regenerate the energy storage device and drive the first driven shaft at overrun speeds relative to the first drive shaft, and wherein the second motor-generator is configured to alternately regenerate the energy storage device and drive the second driven shaft at overrun speeds relative to the second drive shaft.
